(19) United States
(12) Patent Application Publication
(10) Pub. No.: US 2003/0209089 A1
(43) Pub. Date: Nov. 13, 2003

(54) Weighing cell

(75) Inventor: Michael Schurr, Murrhardt (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Soehnle-Waagen GmbH & Co. KG, Murrhardt (DE)

(21) Appl. No.: 10/394,293

(22) Filed: Mar. 21, 2003

(30) Foreign Application Priority Data
Mar. 23, 2002 (DE) DE 102 13 078.7
Jul. 2, 2002 (DE) DE 102 29 739.8

(51) Int. Cl. G01L 1/04

(52) U.S. Cl. 73/862.637

(57) ABSTRACT

A weighing cell is provided which includes a resilient bending bar, and a plurality of resistance measuring gauges that are arranged perpendicular to each other in respective blocks on the resilient bending bar, wherein the resistance measuring gauges are disposed symmetrically with respect to a longitudinal axis of the resilient bending bar.

### FIELD OF THE INVENTION

The invention relates to a weighing cell comprising a resilient bending bar, and a plurality of resistance measuring gauges which are arranged perpendicular to each other in respective blocks on the resilient bending bar.

### BACKGROUND OF THE INVENTION

Weighing cells are used for both household and industrial scales. They are used especially where high accuracy is to be attained under various conditions of use and various environmental conditions.

It is known to provide resilient bending bars with a plurality of resistance measuring strips, or gauges, in so-called strain gauge applications. Conventionally, weighing cells having locally distributed adhesively bonded strain gauges have been used, but this structure necessitates complicated interconnection because of the spacings between the strain gauges, and moreover weighing cells with this structure are quite vulnerable to temperature gradients.

It is also known to dispose a plurality of strain gauges on one resilient bending bar, which reduces the effort and expense for interconnection. This structure, however, has the disadvantage that the sensitivity to temperature gradients becomes even greater. This leads to zero-signal changes that are not compensated for until the temperature level has stabilized.

European Patent EP 0 244 324 B1 and corresponding U.S. Pat. No. 4,787,256 disclose a force transducer having resistance measuring gauges that are disposed perpendicular to one another on a resilient bending bar. A disadvantage of the structure disclosed in these references, however, is that torsional stresses are also measured, which necessarily leads to imprecision.

### OBJECT OF THE INVENTION

The object of the invention is to provide a weighing cell comprising a resilient bending bar having resistance measuring gauges provided thereon in a manner so that the weighing cell is insensitive to both torsional stresses and major temperature changes. In addition, it is also an object of the invention to provide such a weighing cell which can nevertheless be manufactured simply—namely, without an increase in consumption of material and with little effort or expense for interconnection.

### SUMMARY OF THE INVENTION

To attain the object of the invention, a weighing cell is provided which comprises a resilient bending bar, and a plurality of resistance measuring gauges that are arranged perpendicular to each other in respective blocks on the resilient bending bar, wherein the resistance measuring gauges are disposed symmetrically with respect to a longitudinal axis of the resilient bending bar.

According to one embodiment of the invention, two blocks of resistance measuring gauges are provided on the resilient bending bar, and each block comprises a first resistance measuring gauge for measuring tensile and compressive stresses disposed centrally on the longitudinal axis of the resilient bending bar, and two second resistance measuring gauges for measuring transverse contraction respectively disposed on both sides of the first resistance measuring gauge symmetrically with respect to the longitudinal axis of the resilient bending bar and perpendicular to the first resistance measuring gauge.

According to another embodiment of the invention, two blocks of resistance measuring gauges are provided on the resilient bending bar, and each block comprises a first resistance measuring gauge for measuring transverse contraction disposed centrally on the longitudinal axis of the resilient bending bar, and two second resistance measuring gauges for measuring tensile and compressive stresses respectively disposed on both sides of the first resistance measuring gauge symmetrically with respect to the longitudinal axis of the resilient bending bar and perpendicular to the first resistance measuring gauge.

According to the preferred embodiments of the invention, the resistance measuring gauges are all provided on one side of the resilient bending bar, and the resilient bending bar is a double bending bar.

Thus, according to the invention, by symmetrically arranging the resistance measuring gauges with respect to the longitudinal axis of the resilient bending bar, torsional stresses are eliminated. In addition, this structure is not vulnerable to temperature gradients, so that the measurement results remain constant under all usage conditions. Still further, the effort and expense for interconnection is relatively slight, and because the resistance measuring gauges may be adhesively bonded on only one side of the resilient bending bar, manufacture is simple.

### BRIEF DESCRIPTION OF THE DRAWINGS

FIG. 1 is a sectional view through a weighing cell region of a platform scale;

FIG. 2 shows a perspective view of a weighing cell according to one embodiment of the invention with two resistance measuring gauges for measuring normal stresses and four resistance measuring gauges for measuring transverse contraction;

FIG. 3 shows a perspective view of a weighing cell according to another embodiment of the invention with two resistance measuring gauges for measuring transverse contraction, and four resistance measuring gauges for measuring normal stresses; and

FIG. 4 shows a Wheatstone bridge according to the invention.

### DETAILED DESCRIPTION

Two exemplary embodiments of the invention will be described in detail below in conjunction with the drawings.

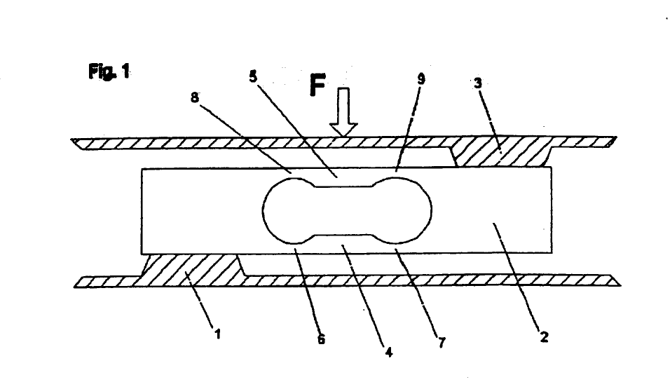

FIG. 1 shows a weighing cell comprising a resilient bending bar 2 disposed between a base plate 1 and a load plate 3 in a platform scale. A force of gravity F can be applied to the load plate 3 at any arbitrary point. The resilient bending bar 2 is embodied as a so-called double bending bar, and has a lower steering arm 4 and an upper steering arm 5. The lower steering arm 4 is formed by bending points 6 and 7, and the upper steering arm 5 is formed by bending points 8 and 9. When the load plate 3 is acted on by the force of gravity F, bending stresses occur at the bending points 6, 7, 8, 9. These stresses are tensile stresses for the rectilinear outer faces of the bending points 7 and 8 and compressive stresses for the rectilinear outer faces of the bending points 6 and 9.

Resistance measuring gauges or strips are applied to the bending points and interconnected to make a Wheatstone bridge.

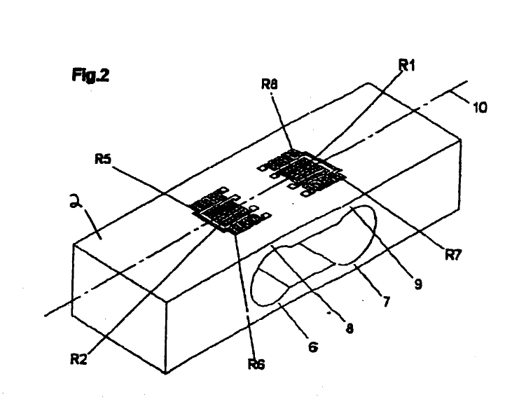

According to one exemplary embodiment of the invention as shown in FIG. 2, at each of the two bending points 8 and 9 of the resilient bending bar 2, resistance measuring gauges or strips R1 and R2 are provided for measuring tensile and compressive stresses, and resistance measuring gauges or strips R5, R6 and R7, R8 for measuring transverse contraction are applied to both sides of the measuring gauge R1. Thus, at each of the two bending points 8 and 9, both tensile stresses and compressive stresses are measured. The measuring gauges R5, R6, R7, R8 for transverse contraction measurement are disposed at an angle of 90° to the measuring gauges R1 and R2. And it is noted that the value of transverse contraction, in metals, is approximately 30% of the normal elongation.

With the structure shown in FIG. 2, the resistance measuring gauges R1 and R2 for measuring the normal stress are placed symmetrically on the longitudinal axis 10 of the resilient bending bar 2, thereby precluding torsional stresses. In addition, the transverse contraction measurement is effected via each two resistance measuring gauges R5, R6 and R7, R8, respectively, which are likewise disposed symmetrically to the longitudinal axis 10 of the resilient bending bar 2.

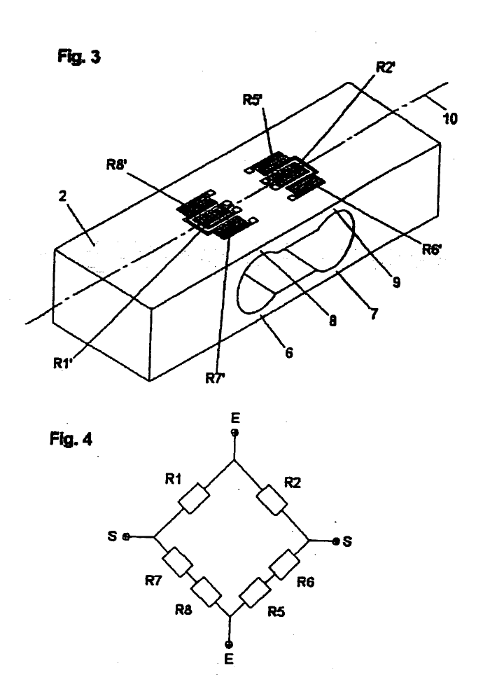

FIG. 3 shows another exemplary embodiment of the invention in which measuring gauges or strips R1′ and R2′ for transverse contraction measurement are placed symmetrically on the longitudinal axis 10 of the resilient bending bar 2. In this exemplary embodiment, the measurement of the normal stress is effected via each two measuring strips R5′, R6′ and R7′, R8′, respectively, which are likewise disposed symmetrically to the longitudinal axis 10 and perpendicular to the resistance measuring gauges R1′ and R2′, respectively.

The interconnection of the measuring gauges is effected in accordance with the Wheatstone bridge shown in FIG. 4, whereby the measuring gauges at one bending point form a so-called half bridge. The input is marked E and the signal is marked S.

It is noted that if, for example, the bending point 9 shown in FIG. 2 heats up as compared to the bending point 8, then the measuring strips R1, R7 and R8 change their resistance by ΔR1, ΔR7 and ΔR8. In this case, the following equations apply:

R1=R7+R8

ΔR1=ΔR7+ΔR8

The Wheatstone bridge, however, has the property that changes in resistance in the same direction, i.e., ΔR1 and ΔR7+ΔR8 in adjacent bridge branches cancel one another out. Thus even at major temperature gradients, only minimal zero-signal changes would occur. And as a result, because of their high temperature constancy, the weighing cells of the invention can be used universally.

It is also noted that as a result of the transverse contraction measurement, the weighing cell of the invention, with the same dimensioning as the weighing cell of the prior art, furnishes a slighter output signal. However, this is only of slight significance and could, if necessary for certain usage conditions, readily be eliminated by re-dimensioning the bending points and/or by using a spring material with a correspondingly higher strain limit.

As noted above, the resilient bending bar of the invention is preferably embodied as a so-called double bending bar. This enables greater freedom in designing a scale. Naturally, however, it would also be possible to use a single bending bar.

According to the preferred embodiments shown in FIGS. 2 and 3, the measuring gauges or strips are preferably applied to one side of the resilient bending bar 2.

However, it is noted that it is also possible to shift the transverse contraction measurement to the axis of symmetry of the resilient bending bar, and to perform measurement of the normal stress by way of measuring gauges or strips which are disposed on both sides of the resilient bending bar.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

We claim:

1. A weighing cell comprising:
a resilient bending bar, and
a plurality of resistance measuring gauges that are arranged perpendicular to each other in respective blocks on the resilient bending bar,
wherein the resistance measuring gauges are disposed symmetrically with respect to a longitudinal axis of the resilient bending bar.

2. The weighing cell of claim 1, wherein two blocks of resistance measuring gauges are provided on the resilient bending bar, and each block comprises:
a first resistance measuring gauge for measuring tensile and compressive stresses disposed centrally on the longitudinal axis of the resilient bending bar, and
two second resistance measuring gauges for measuring transverse contraction respectively disposed on both sides of the first resistance measuring gauge symmetrically with respect to the longitudinal axis of the resilient bending bar and perpendicular to the first resistance measuring gauge.

3. The weighing cell of claim 1, wherein two blocks of resistance measuring gauges are provided on the resilient bending bar, and each block comprises:
a first resistance measuring gauge for measuring transverse contraction disposed centrally on the longitudinal axis of the resilient bending bar, and
two second resistance measuring gauges for measuring tensile and compressive stresses respectively disposed on both sides of the first resistance measuring gauge symmetrically with respect to the longitudinal axis of the resilient bending bar and perpendicular to the first resistance measuring gauge.

4. The weighing cell of claim 1, wherein the resistance measuring gauges are all provided on one side of the resilient bending bar.

5. The weighing cell of claim 2, wherein the resistance measuring gauges are all provided on one side of the resilient bending bar.

6. The weighing cell of claim 3, wherein the resistance measuring gauges are all provided on one side of the resilient bending bar.

7. The weighing cell of claim 1, wherein the resilient bending bar is a double bending bar.

8. The weighing cell of claim 2, wherein the resilient bending bar is a double bending bar.

9. The weighing cell of claim 3, wherein the resilient bending bar is a double bending bar.
